(19) United States
(12) Patent Application Publication
(10) Pub. No.: US 2009/0060326 A1
(43) Pub. Date: Mar. 5, 2009

(54) IMAGE PROCESSING APPARATUS AND METHOD

(76) Inventors: Yoshie IMAI, Kanagawa-ken (JP); Goh ITOH, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/197,576

(22) Filed: Aug. 25, 2008

(30) Foreign Application Priority Data
Aug. 28, 2007 (JP) P2007-221543

(51) Int. Cl. G06K 9/00

(52) U.S. Cl. 382/167

(57) ABSTRACT

An objective color for a target color is set based on characteristic of the target color on a hue area to which the target color belongs in a color space represented by lightness, chroma and hue, and a shape of the most outer point of a color gamut reproducible by an output device on the hue area. A correction coefficient is calculated based on lightness, chroma and hue of the target color, lightness, chroma and hue of the objective color, a distance between the most outer point and the target color in the color space, and a distance between the most outer point and the objective color in the color space. A color correction quantity of each pixel of the image is calculated based on a distance between the target color and the objective color in the color space, a distance between the target color and a color of each pixel in the color space, the correction coefficient, and lightness and chroma of each pixel. The color of each pixel is corrected based on the color correction quantity.

### CROSS-REFERENCE TO RELATED APPLICATIONS

This application is based upon and claims the benefit of priority from prior Japanese Patent Application No.2007-221543, filed on Aug. 28, 2007; the entire contents of which are incorporated herein by reference.

### FIELD OF THE INVENTION

The present invention relates to an image processing apparatus and method for correcting color of an input image by referring to color distribution and vision characteristic of the image.

### BACKGROUND OF THE INVENTION

With regard to a color reproducibility of a color image device, an objective based on the purpose exists. For example, as to a hard-copy machine or a printer, an original object is required to be truly reproduced. As to a photograph, a scene is recorded onto film by adjusting an exposure time, and the color of an image on the film is converted to a preferred color for human vision by differentiating a developing time. Recently, reproduction of a preferred color is applied to a digital camera. Especially, a human's memory color of which representative color is a skin color, a sky blue, or a grass green, is corrected as the preferred color.

In order to reproduce color on a photograph, brightness or color on the whole image is corrected. In general, color is distributed within a color gamut (color-reproducible area) by brightening or deepening color, and color reproducibility is improved. In this case, a specific color cannot be individually corrected. If a range of the specific color is set as a correction object, its correction is affected on the whole image, and corrected color excessively spreads.

In case of color-reproduction for the digital camera, an area to correct color (such as skin color) is specifically extracted, and corrected as a predetermined preferred color. In this case, brightness and color on the image can be partially corrected. Accordingly, the corrected color does not excessively spread, which is different from above-mentioned case. Such model for selective color adjustment is disclosed in “Image Signal Processing for Hardcopy”, Kotera, The journal of the Institute of Television Engineers of Japan, Vol. 43, No. 11, 1989, pp. 1205-1212.

In this model, an area of specific color is specified and freely deviated as some quantity along some direction in a color space. The objective is to retain continuity in the color space and cope with a variation of color distribution in the image. In order to realize this objective, a membership function is used for indicating a color area, and the color is sensitively adjusted by a hue change quantity and a chroma scaling factor. However, concrete means to realize such function is not disclosed.

In JP-A No. 2006-31375, a concrete method to preferably reproduce a memory color is disclosed. In this reference, in the same way as in the above-mentioned model, a hue and a chroma are only converted.

In case of spreading a color gamut, as mentioned-above, the color is excessively converted. Especially, if a chroma is excessively emphasized, the human conversely feels that color reproducibility drops. The reason is that the color conversion is not based on a color distribution of the image.

As shown in JP-A No. 2006-31375, by representing a memory color with a preferred color, color reproducibility improves. However, an area of the memory color does not always occupy a major part of the image. For example, in case of taking a photograph of a person as a relative small size against scenery except for a blue sky or a green grass, a factor for a user to determine impression of the photograph is not a skin color of the person. In this case, correction of the memory color is not effective. Furthermore, balance of the memory color with surrounding colors is not taken into consideration, and an image having well-balanced color as a whole is not generated.

Furthermore, color attribute is not only hue and chroma (disclosed in JP-A No.2006-31375); lightness is an important factor. FIG. 1 is a schematic diagram of a color space (a uniform color space) represented by lightness, chroma, and hue. FIG. 2 is a schematic diagram of three-dimensional color gamut having outer points on the surface in the color space. As shown in FIGS. 1 and 2, in the color space suitable for vision, a shape of color gamut is largely different based on the hue, lightness, and chroma of the most outer point (having the longest distance on the surface from the origin of three axes) of the color gamut. Accordingly, by spreading the color gamut or converting the memory color, color-balance of the image often breaks. In order to reproduce preferred colors, not only the hue and the chroma, but the lightness should be suitably converted.

### SUMMARY OF THE INVENTION

The present invention is directed to an image processing apparatus and method for converting an input image to an output image having a preferred color with color balance.

According to an aspect of the present invention, there is provided an apparatus for processing an image, comprising: an object color set unit configured to set a target color to be corrected in the image; a target color set unit configured to set an objective color to correct the target color, based on characteristic of the target color on a hue area to which the target color belongs in a color space represented by lightness, chroma, and hue, and a shape of the most outer point of a color gamut reproducible by an output device on the hue area; a correction coefficient calculation unit configured to calculate a correction coefficient for each pixel of the image, based on lightness, chroma, and hue of the target color, lightness, chroma, and hue of the objective color, a distance between the most outer point and the target color in the color space, and a distance between the most outer point and the objective color in the color space; a correction quantity calculation unit configured to calculate a color correction quantity of each pixel of the image, based on a distance between the target color and the objective color in the color space, a distance between the target color and a color of each pixel in the color space, the correction coefficient, and lightness and chroma of each pixel; and a color correction unit configured to correct the color of each pixel based on the color correction quantity.

According to another aspect of the present invention, there is also provided a method for processing an image, comprising: setting a target color to be corrected in the image; setting an objective color to correct the target color, based on characteristic of the target color on a hue area to which the target color belongs in a color space represented by lightness, chroma, and hue, and a shape of the most outer point of a color gamut reproducible by an output device on the hue area; calculating a correction coefficient for each pixel of the image, based on lightness, chroma, and hue of the target color, lightness, chroma, and hue of the objective color, a distance between the most outer point and the target color in the color space, and a distance between the most outer point and the objective color in the color space; calculating a color correction quantity of each pixel of the image, based on a distance between the target color and the objective color in the color space, a distance between the target color and a color of each pixel in the color space, the correction coefficient, and lightness and chroma of each pixel; and correcting the color of each pixel based on the color correction quantity.

According to still another aspect of the present invention, there is also provided a computer readable medium storing program codes for causing a computer to process an image, the program codes comprising: a first program code to set a target color to be corrected in the image; a second program code to set an objective color to correct the target color, based on characteristic of the target color on a hue area to which the target color belongs in a color space represented by lightness, chroma, and hue, and a shape of the most outer point of a color gamut reproducible by an output device on the hue area; a third program code to calculate a correction coefficient for each pixel of the image, based on lightness, chroma, and hue of the target color, lightness, chroma, and hue of the objective color, a distance between the most outer point and the target color in the color space, and a distance between the most outer point and the objective color in the color space; a fourth program code to calculate a color correction quantity of each pixel of the image, based on a distance between the target color and the objective color in the color space, a distance between the target color and a color of each pixel in the color space, the correction coefficient, and lightness and chroma of each pixel; and a fifth program code to correct the color of each pixel based on the color correction quantity.

### BRIEF DESCRIPTION OF THE DRAWINGS

FIG. 1 is a schematic diagram of a color space represented by lightness, chroma, and hue.

FIG. 2 is a schematic diagram of three-dimensional color gamut having outer points on the surface in the color space.

FIG. 3 is a flow chart of processing of an image processing method according to a first embodiment.

FIG. 4 is a schematic diagram of a color space having an objective color, a target color, and an object pixel to be corrected.

FIG. 5 is a block diagram of an image processing apparatus according to the first embodiment.

FIG. 6 is a flow chart of processing of the image processing method according to a second embodiment.

### DETAILED DESCRIPTION OF THE EMBODIMENTS

Hereinafter, various embodiments of the present invention will be explained by referring to the drawings. The present invention is not limited to the following embodiments.

### First Embodiment

The image processing method of the first embodiment is presented as an image processing module of a digital camera, a cellular-phone, a television, or a computer programmed with application software.

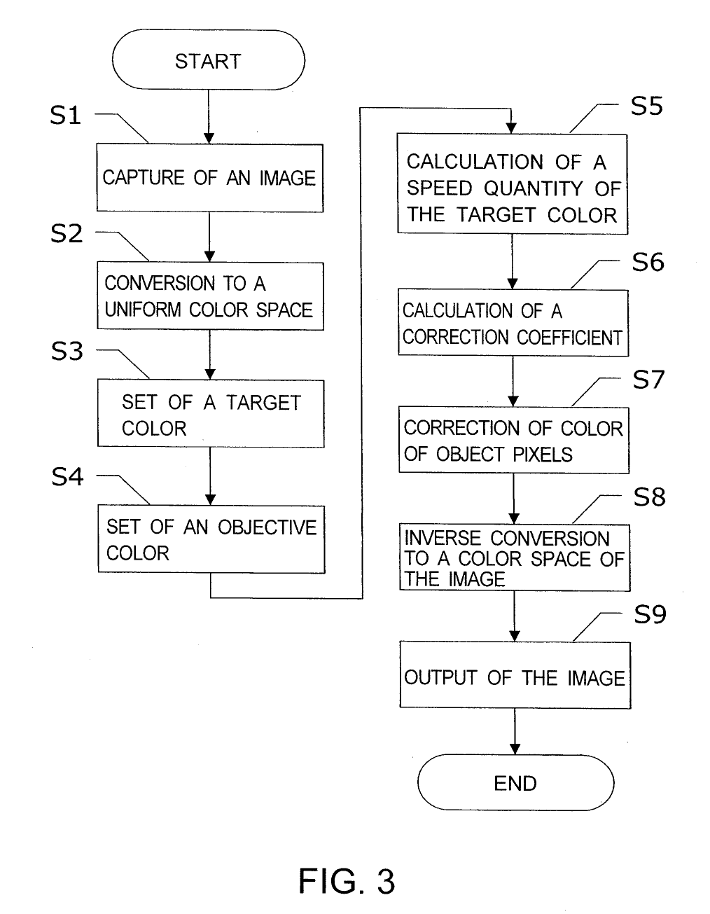

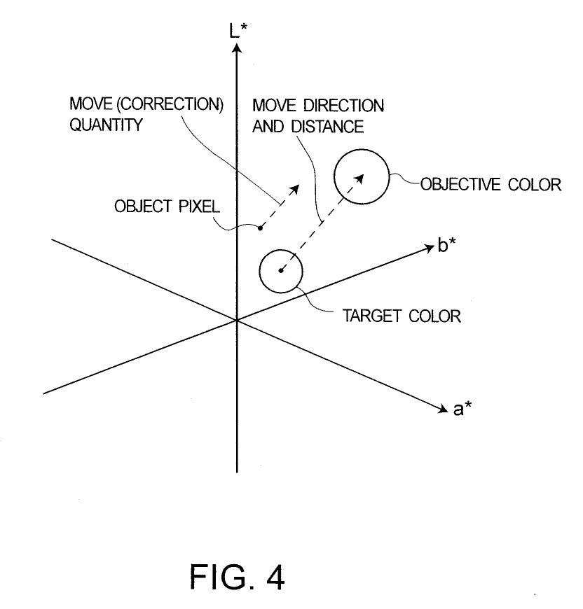

FIG. 3 is a flow chart of processing of the image processing method according to the first embodiment. FIG. 4 is a schematic diagram of a color space having an objective color, a target color, and an object pixel to be corrected. First, image data is captured (S1). Next, the image data is converted into a color space having visual uniformity (a uniform color space) (S2). A target color as a correction object is set using the converted data (S3). An objective color as an objective value to correct the target color is set (S4). A spread quantity of the objective color is determined by color distribution adjacent to the target color in the color space (S5). A correction coefficient is calculated using the target color, the objective color, the spread quantity, and a distance between the target color and the most outer point of a color gamut reproducible by an output device (S6). With regard to each pixel on the image, color is corrected using values determined at S3˜S6 (S7). Each pixel having the corrected color is inversely converted into a color space of the image (an original color space) (S8). The image comprising each pixel having the corrected color is output (S9).

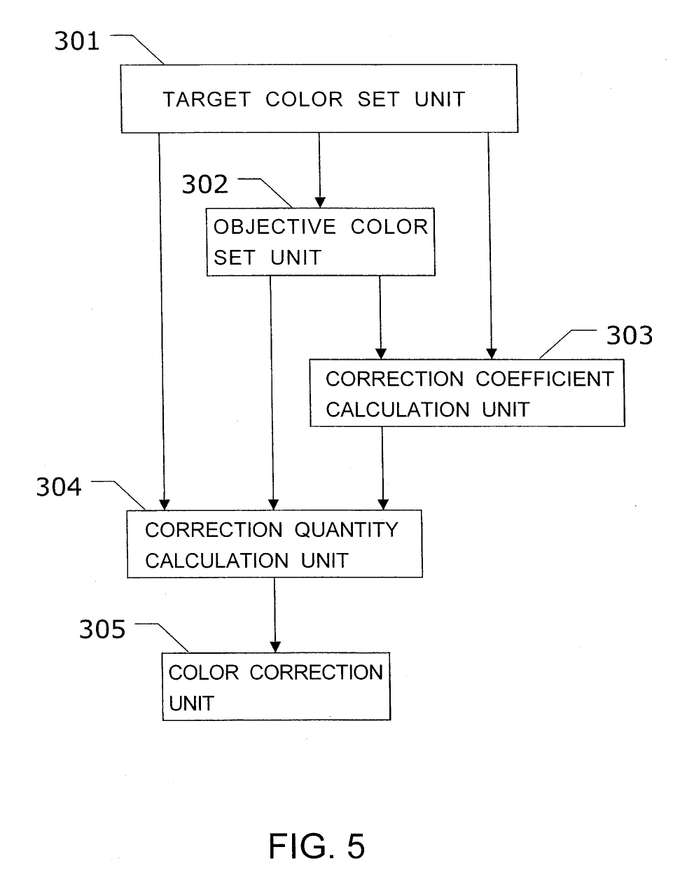

FIG. 5 is a block diagram of an image processing apparatus according to the first embodiment. A target color set unit 301 sets a target color as a correction object. An objective color set unit 302 sets an objective color as an objective value to correct the target color. A correction coefficient calculation unit 303 calculates a correction coefficient using the target color, the objective color, the spread quantity, and a distance between the target color and the most outer point of a color gamut reproducible by an output device. A correction quantity calculation unit 304 calculates a color correction quantity of each pixel using a distance between the target color and the objective color in the color space, a distance between the target color and a color of each pixel in the color space, the correction coefficient, and lightness and chroma of each pixel. A color correction unit 305 corrects the color of each pixel using the color correction quantity of each pixel, and outputs image data having each pixel with the corrected color.

Next, each step in FIG. 3 is explained in more detail. An image captured at S1 is an image of M×N pixels having M units of pixels along a horizontal direction and N units of pixels along a vertical direction. This image is an RGB image, and each pixel has gradation data of red, green, and blue. The gradation data of each element (red, green, blue) is represented by eight bits.

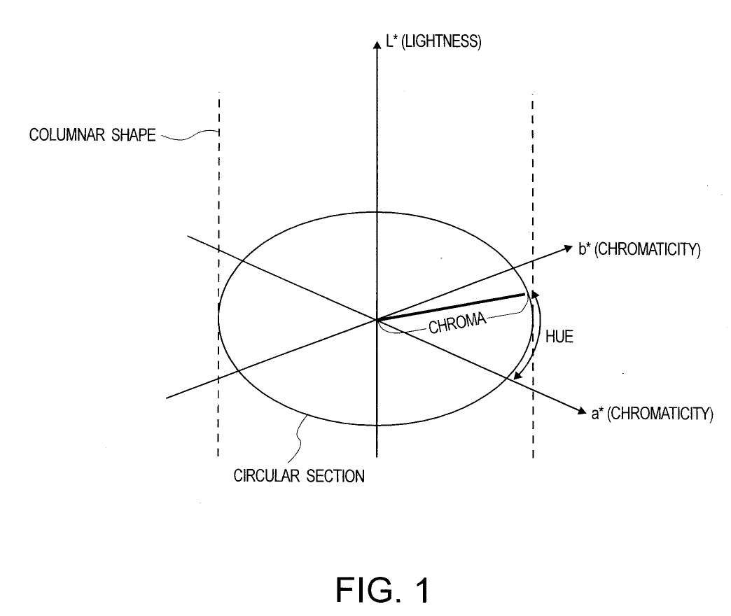

At S2, the image data is converted to a visual uniform space, i.e., CIELAB color space or CIELCH color space. As shown in FIG. 1, the CIELAB color space is consisted of three axes of L* (lightness) , a* and b* (each color degree) , which is a uniform color space superior in color conversion with spatial continuity. The CIELCH color space represents the CIELAB color space in a columnar coordinate system, and a* and b* are replaced with chroma C and hue H. Three attributes of color are lightness, chroma, and hue. Accordingly, the CIELCH color space is a color space able to easily decide which characteristic the color has.

At S3, the objective color is extracted. In the present embodiment, the objective color is defined as a color to determine impression of the image. For example, a color having a major area in the picture, or a color having characteristic largely different from another color having the major area (i.e., accent color or conspicuous color), may be the objective color. Furthermore, a skin color, a blue sky, and a green grass, which are important for human's memory color, may be included.

With regard to a color having major area in the image, a sphere of the color is limited. In this case, classification based on vision in the color space is used. For example, with regard to Munsell notation color system, color patches of which three attributes are different are arranged in order and displayed with a series of numerical values assigned to each color patch. With regard to Munsell renotation color system, the Munsell notation color system is rationally modified so that arrange order has uniformity based on colorimetry value. In JIS Z 8721 for the Munsell renotation color system, tristimulus values are corresponded. In case of fixing an illumination, the colorimetry value in the uniform color space is calculated from the tristimulus values. In JIS Z 8102 for the Munsell renotation color system, the color names are limitedly classified by a suitable section representing impression of each color. This classification is called “a tone”. Hereinafter, all the color space (having visual classification) represented by lightness, chroma, and hue, is called “a tone space”.

At S3, by calculating a histogram in the tone space, a color having the major area in the image is extracted from target colors. For example, an area of each color is decided by a ratio of the number of pixels having the color to the number of all pixels. However, in case of also extracting another tone adjacent to the color having the major area, it is necessary to decide whether the color and another tone have color distribution as one unity in the color space.

Furthermore, by extracting a color having characteristic largely different from the target color, an accent color or a conspicuous color can be extracted as another target color. Furthermore, by corresponding the above-mentioned classification with the memory color (a limit to be extracted), the memory color can be extracted. However, this memory color may be specially indicated.

With regard to the target color as the extraction result, all the area of the target color can be indicated. However, in order to easily calculate, a center of gravity of the area is selected.

At S4, an objective value to correct the target color (set at S3) is set to an objective color. In case of the memory color, the objective color may be converted to a preferred range for a human. As the memory color, the objective value is previously set into a database. However, as mentioned-above, the target color is not limited to the memory color. Accordingly, how to convert another target color so that the image is favorably reproduced must be considered.

In general, a human viewer has a tendency to decide that the image is rich in gradation by widely spreading color within a color gamut. Furthermore, the human viewer has a tendency to prefer an image having proper lightness and brightness. However, in case of too light or bright, the human decides that the color reproducibility drops.

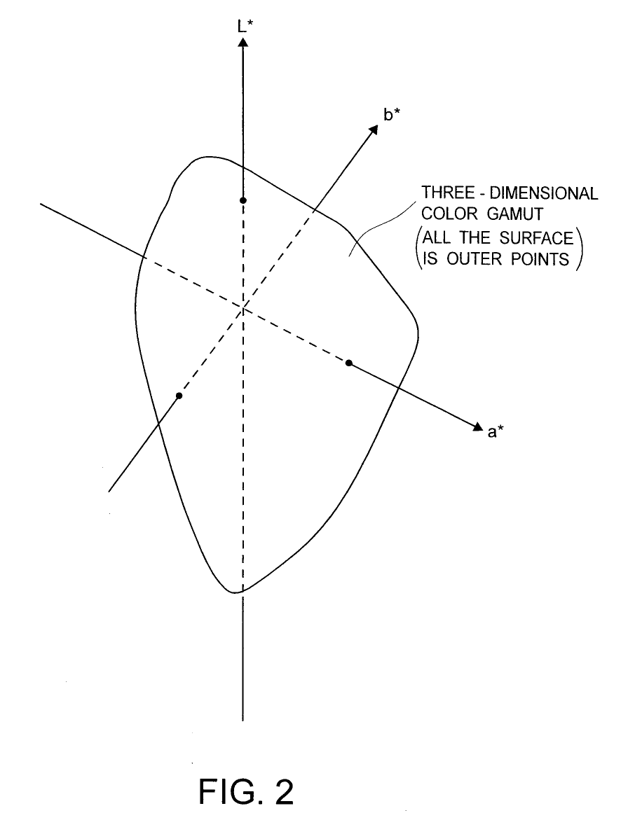

In case of spreading a color gamut of the image, a shape of the color gamut is largely different based on the hue as shown in FIGS. 1 and 2. Briefly, spread direction and quantity of the color gamut are different based on three attributes (lightness, chroma, hue) of the target color. For example, bright color having yellow hue has a high lightness while bright color having blue hue has a low lightness. Accordingly, among the three attributes of the target color, especially, a move direction and distance of the target color in the color space are determined by the hue.

In case of determining a move direction and distance of the target color, in the color space represented by lightness, chroma, and hue, an area of hue to which the target color belongs is important. If the target color is represented as one point, the area of hue of the target color is a surface (a circular arc) having a fixed hue in the color space as shown in FIG. 1. If the target color has spread quantity, the area of hue of the target color is a space (a part of columnar shape) having predetermined width of hue (distribution width along L* axis) in the color space as shown in FIG. 1. The move direction and distance of the target color are determined by a characteristic of the target color in the area and a shape of the most outer point of a color gamut reproducible of an output device in the area. As shown in FIG. 2, the most outer point on the surface of the color gamut is a point having the longest distance from the origin of three axes (L*, a*, b*) in the color space. For example, the move direction and distance of the target color are determined by the maximum chroma and lightness of the color gamut in the area of hue to which the target color belongs. This objective value may be calculated or referred to a value stored in a look-up table (LUT).

Next, at S5, a spread quantity of the target color is decided. As explained at S3, the target color is set as the center of gravity of classified tone (area of the target color) However, color distribution actually occurs in the classified tone. Furthermore, color distribution of another tone adjacent to the classified tone should be taken into consideration. If only the area of the classified tone is taken into consideration, tone-jump may occur in continuous gradation of pixels on the image.

Next, at S6, a correction coefficient is calculated based on characteristic of the color space. For example, in an area having very low chroma (achromatic color), in case of spreading the color in a color gamut, coloring makes incompatibility larger and image quality drops. On the other hand, in an area having high chroma, the color should be converted not to protrude from the (reproducible) color gamut and not to be broken. This policy can be represented by multi-dimensional function or a function having (one or a plurality of) exponentiations or logarithms. The correction coefficient is a value to determine characteristic of this function. Furthermore, with regard to lightness, in an area having high lightness or low lightness, it is desired that the color is not too changed with conversion. This policy can be also controlled by the function in the same way as chroma.

At S7, the color is corrected using values determined at S3˜S6. A direction to correct the color is determined at S4. However, the correction quantity is calculated using a membership function.

With regard to the membership function, the following items are considered.

(1) A distance between the target color and a color of an object pixel (of the image) in the color space

(2) Lightness

(3) Chroma

(4) Color distribution

The coefficients of the membership function of lightness and chroma are calculated at S6.

With regard to items (1)˜(4), equations of coefficients of the membership function is represented as follows.

Color of object pixel: (Lᵢⱼ,aᵢⱼ,bᵢⱼ) in CIELAB color space
(Lᵢⱼ,Cᵢⱼ,Hᵢⱼ) in CIELCH color space

Target color: (L_{d},a_{d},b_{d})

Objective color: (L_{d}′,a_{d}′,b_{d}′)

$$\begin{matrix}{k}_{dis} = {α}_{dis} * \{ {( {L}_{d} - {L}_{i , j} )}^{2} + {( {a}_{d} - {a}_{i , j} )}^{2} + {( {b}_{d} - {b}_{i , j} )}^{2} \} + 1 & ( 1 ) \\ {k}_{L} = \{ \begin{matrix}{α}_{L} * {L}_{i , j} & 0 ≺ {L}_{i , j} \leq {L}_{lower} \\ 1 & {L}_{lower} ≺ {L}_{i , j} \leq {L}_{upper} \\ - {α}_{L} * {L}_{i , j} & {L}_{upper} ≺ {L}_{i , j} \leq 100\end{matrix} & ( 2 ) \\ {k}_{L} = \{ \begin{matrix}{α}_{C} * {C}_{i , j} & 0 ≺ {C}_{i , j} \leq {C}_{lower} \\ 1 & {C}_{lower} ≺ {C}_{i , j} \leq {C}_{upper} \\ - {α}_{C} * {C}_{i , j} & {C}_{upper} ≺ {C}_{i , j} \leq {C}_{Max}\end{matrix} & ( 3 ) \\ {k}_{dev} = {α}_{dev} * ( {β}_{dev} - {DEV}_{{( L , a , b )}_{d}} ) & ( 4 )\end{matrix}$$

DEV_{(L,a,b)d}: Distributed value in tone of target color

A correction quantity is calculated using the membership function. By multiplying the correction quantity with a move direction and distance between the target color and the objective color, a move quantity (actual correction quantity) of a pixel value (color value) of an object pixel is calculated. By adding the move quantity to the pixel value of the object pixel, the pixel value of the object pixel is corrected as shown in FIG. 4. An equation to correct the pixel value of the object pixel is represented as follows.

(L′,a′,b′)_{i,j}=(L,a,b)_{i,j}+k_{dis}*k_{L}*k_{C}*k_{dev}*{(L′,a′,b′)_{d}−(L,a,b)_{d}}

As to all pixels on the image, the move quantity of the pixel value of each pixel is calculated for each target color. With regard to each pixel, the move quantity may be calculated for one target color having the nearest distance from the object pixel in the color space. A continuous convertion of the pixel value of the object pixel in the color space helps to avoid tone-jump and artifact.

In this way, after correction at S7, a color of each pixel on the image is corrected to reproduce a preferred color on the image as a whole. Hereinafter, at S8, a corrected color of each pixel in the equal color space is reconverted to an original color space of the image. At S9, reconverted image data in the original color space is output. In order to store/display the image, the reconverted image data is necessary to match with the original image data.

The pixel value of each pixel on the image is not limited to RGB data of eight bits. The pixel value may be image data (such as YCC data or XYZ data) visually conversable into a uniform color space. The number of bits of the pixel value is not limited to eight bits. Furthermore, the uniform color space may be not CIELAB color space but CIELUV color space.

In the first embodiment, as color-classification, Musell renotation color system and JIS color system are used. However, if only the color classification corresponds to the uniform color space, any color system can be used. For example, another color space such as PCCS (Practical Color Co-ordinate System) or CCIC (the Chamber of Commerce & Industry Color Coordination Chart) may be used.

### Second Embodiment

In the same way as in the first embodiment, the image processing method of the second embodiment is presented as an image processing module of a digital camera, a cellular-phone, a television, or a computer programmed with application software.

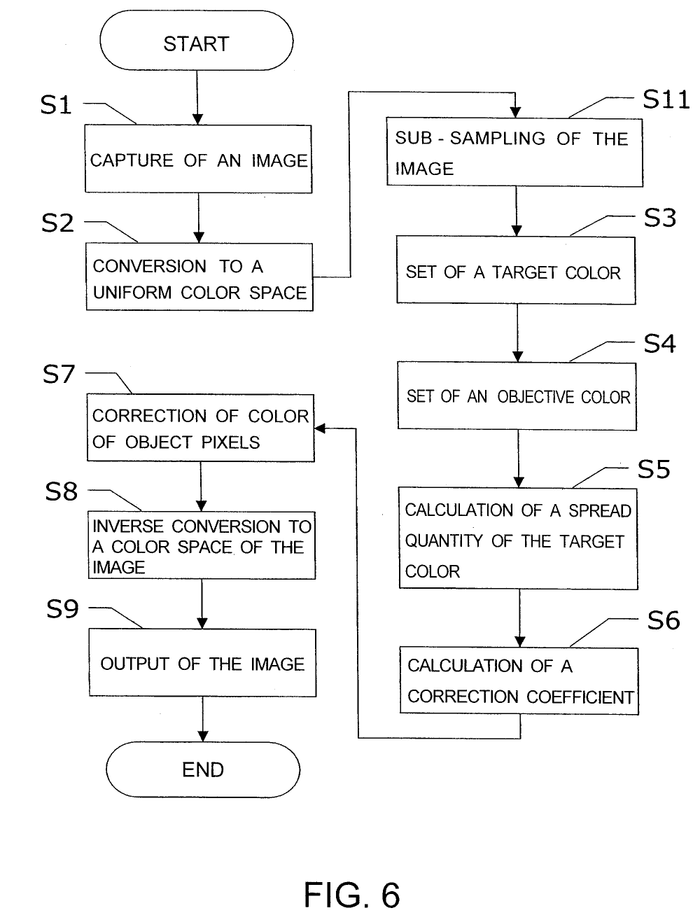

FIG. 6 is a flow chart of processing of the image processing method according to the second embodiment. First, image data is captured (S1). Next, the image data is converted into a color space having visual uniformity (a uniform color space) (S2). Next, by sub-sampling the converted image data, a reduced image data (small-sized converted image) is generated (S11). A target color as a correction target is set using the reduced image data (S3). An objective color as an objective value to correct the target color is set (S4). A spread quantity of the objective color is determined by color distribution adjacent to the target color in the color space (S5). A correction coefficient is calculated using the target color, the objective color, the spread quantity, and a distance between the target color and the most outer point of a color gamut reproducible by an output device (S6). With regard to each pixel on the image (original-sized image), color is corrected using values determined at S3˜S6 (S7). Each pixel having the corrected color is inversely converted into a color space (original color space) of the image (S8). The image comprising each pixel having the corrected color is output (S9).

In the second embodiment, processing at S3˜S6 is subjected to the reduced image. Accordingly, in comparison with the first embodiment, the calculation time can be reduced.

With regard to sub-sampling at S11, it is desired that the original image data is reduced by the nearest neighbor method. If a pixel value of another pixel adjacent to the object pixel is convoluted, a colorimetry value not included in the original image is generated for the object pixel. As a result, the colorimetry value has bad influence on values calculated at S3˜s6.

Furthermore, the more the image is reduced, the shorter the calculation time is. However, when the image is too reduced, undesirable phenomenon that a thin line on the image is deleted often occurs. Accordingly, the image data should be reduced under the condition that characteristic of the image is not largely deleted. Detail processing of other steps in FIG. 6 is omitted because it is same as the first embodiment.

In the disclosed embodiments, the processing can be accomplished by a computer and a computer-executable program, and this program can be realized in a computer-readable memory device.

In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An apparatus for processing an image, comprising:
a target color set unit configured to set a target color to be corrected in the image;
an objective color set unit configured to set an objective color to correct the target color, based on
characteristic of the target color on a hue area to which the target color belongs in a color space represented by lightness, chroma, and hue, and
a shape of the most outer point of a color gamut reproducible by an output device on the hue area;
a correction coefficient calculation unit configured to calculate a correction coefficient for each pixel of the image, based on
lightness, chroma, and hue of the target color,
lightness, chroma, and hue of the objective color,
a distance between the most outer point and the target color in the color space, and
a distance between the most outer point and the objective color in the color space;
a correction quantity calculation unit configured to calculate a color correction quantity of each pixel of the image, based on
a distance between the target color and the objective color in the color space,
a distance between the target color and a color of each pixel in the color space,
the correction coefficient, and
lightness and chroma of each pixel; and
a color correction unit configured to correct the color of each pixel based on the color correction quantity.

2. The apparatus according to claim 1,
wherein the target color set unit calculates a histogram of the image with regard to each color in the color space, and sets a color having the largest number of pixels to the target color.

3. The apparatus according to claim 1,
wherein the target color set unit calculates a histogram of the image with regard to each color in the color space, and sets a color depart as a predetermined distance in the color space from another color having the largest number of pixels, to the target color.

4. The apparatus according to claim 1,
wherein the target color set unit sets a predetermined color to the target color.

5. The apparatus according to claim 1,
further comprising an image reduction unit configured to generate a reduced image by sub-sampling the image with the nearest neighbor method,
wherein the target color set unit sets the target color using the reduced image, and
wherein the objective color set unit sets the objective color using the reduced image.

6. A method for processing an image, comprising:
setting a target color to be corrected in the image;
setting an objective color to correct the target color, based on
characteristic of the target color on a hue area to which the target color belongs in a color space represented by lightness, chroma, and hue, and
a shape of the most outer point of a color gamut reproducible by an output device on the hue area;
calculating a correction coefficient for each pixel of the image, based on
lightness, chroma, and hue of the target color,
lightness, chroma, and hue of the objective color,
a distance between the most outer point and the target color in the color space, and
a distance between the most outer point and the objective color in the color space;
calculating a color correction quantity of each pixel of the image, based on
a distance between the target color and the objective color in the color space,
a distance between the target color and a color of each pixel in the color space,
the correction coefficient, and
lightness and chroma of each pixel; and
correcting the color of each pixel based on the color correction quantity.

7. A computer readable medium storing program codes for causing a computer to processing an image, the program codes comprising:
a first program code to set a target color to be corrected in the image;
a second program code to set an objective color to correct the target color, based on
characteristic of the target color on a hue area to which the target color belongs in a color space represented by lightness, chroma, and hue, and
a shape of the most outer point of a color gamut reproducible by an output device on the hue area;
a third program code to calculate a correction coefficient for each pixel of the image, based on
lightness, chroma, and hue of the target color,
lightness, chroma, and hue of the objective color,
a distance between the most outer point and the target color in the color space, and
a distance between the most outer point and the objective color in the color space;
a fourth program code to calculate a color correction quantity of each pixel of the image, based on
a distance between the target color and the objective color in the color space,
a distance between the target color and a color of each pixel in the color space,
the correction coefficient, and
lightness and chroma of each pixel; and
a fifth program code to correct the color of each pixel based on the color correction quantity.
